(19) United States
(12) Patent Application Publication
(10) Pub. No.: US 2022/0244224 A1
(43) Pub. Date: Aug. 4, 2022

(54) THERMALLY-CONTROLLED LOW PRESSURE MIXING SYSTEM FOR LIQUID CHROMATOGRAPHY

(71) Applicant: Waters Technologies Corporation, Milford, MA (US)

(72) Inventors: Timothy M. Raymond, Boston, MA (US); Peter MacKinnon, Providence, RI (US); Michael R. Jackson, Woonsocket, RI (US)

(21) Appl. No.: 17/589,061

(22) Filed: Jan. 31, 2022

Related U.S. Application Data
(60) Provisional application No. 63/145,833, filed on Feb. 4, 2021.

(51) Int. Cl. G01N 30/30; G01N 30/54

(52) U.S. Cl. CPC G01N 30/30; G01N 2030/027; G01N 30/54

(57) ABSTRACT

Described is a solvent manager for a liquid chromatography system. The solvent manager includes a temperature control module, a plurality of solvent reservoirs, a gradient proportioning valve and a degasser. The temperature control module maintains a substantially constant temperature of one or more of the plurality of solvent reservoirs, gradient proportioning valve and degasser. The temperature control module may include a thermal chamber having an enclosure with a thermally controlled internal environment and may also include an active thermal element such as one or more heaters. The enclosure may surround at least one of the plurality of solvent reservoirs, gradient proportioning valve and degasser. The temperature control module reduces the negative effects on solvent composition that result from temperature-dependent changes in solvent viscosities and solvent densities. Such changes affect the retention times of analytes eluted from the chromatographic column.

### RELATED APPLICATION

This application claims the benefit of the earlier filing date of U.S. Provisional Patent Application Ser. No. 63/145,833, filed Feb. 4, 2021, and titled “Thermally-Controlled Low Pressure Mixing System for Liquid Chromatography,” the entirety of which is incorporated herein by reference.

### FIELD OF THE INVENTION

The disclosed technology relates generally to a system for delivering a solvent having a temperature-independent solvent composition. More particularly, the disclosed technology relates to a system that reduces or eliminates the compositional error of the delivered solvent due to temperature-dependent viscosity and density changes of the solvents in a mobile phase of a liquid chromatography system.

### BACKGROUND

Chromatography is a set of techniques for separating a mixture into its constituents. For instance, in a liquid chromatography application, a pump takes in and delivers one or more solvents, referred to as the mobile phase, to a sample manager where a sample is injected into the flow of the mobile phase. In an isocratic chromatography application, the composition of the mobile phase solvents remains unchanged, whereas in a gradient chromatography application, the solvent composition varies over time. The mobile phase, carrying the injected sample, passes through a column of particulate matter referred to as the stationary phase. By passing the mobile phase and sample through the column, the various components in the sample separate from each other at different rates and thus elute from the column at different times. A detector receives the elution from the column and produces an output from which the identity and quantity of analytes in the sample may be determined.

Solvent managers are used to generate and deliver the mobile phase to other components of the liquid chromatography system at precise flow rates, pressures, and solvent compositions. In some systems, solvents are metered and mixed at low pressure (i.e., ambient pressure). The metering can be achieved using a gradient proportioning valve which sequentially provides volume contributions of the different solvents used in the mobile phase. Generally, a solvent has a viscosity that is dependent on temperature. Similarly, the mass density of the solvent is dependent on temperature. A change in the viscosity of a solvent results in a different volume of the solvent contributed by the gradient proportioning valve even though the valve actuation time for the corresponding solvent remains constant. Likewise, a change in the density of a solvent results in a different mass of the solvent contributed by the gradient proportioning valve even if the contributed volume of the corresponding solvent were to be held constant. The relative changes in viscosity are different for the different solvents and the relative changes in density are different for the different solvents. Generally, changes in density have a significantly reduced effect on mass composition as compared to changes in viscosity.

Thus, changes in temperature generally cause a change in the solvent composition and the desired solvent composition may not be realized. Temperature changes may be due to variations in the ambient temperature, especially in environments that do not have accurate temperature control. Such temperature variations and the resulting changes in solvent composition affect the retention times of the analytes eluted from the column. Consequently, chromatography measurement data and data repeatability can be adversely affected by these temperature variations even though the volumes of the solvents may be accurately metered.

### SUMMARY

In one aspect, a liquid chromatography system includes a solvent manager and a temperature control module. The solvent manager includes a plurality of solvent reservoirs and a gradient proportioning valve in fluid communication with the plurality of solvent reservoirs. The temperature control module is disposed in the solvent manager and is configured to maintain a substantially constant temperature of at least one of the plurality of solvent reservoirs and the gradient proportioning valve.

The solvent manager may further include a degasser disposed between the plurality of solvent reservoirs and the gradient proportioning valve and the temperature control module may be configured to maintain a substantially constant temperature of at least one of the plurality of solvent reservoirs, the gradient proportioning valve, and the degasser. At least a portion of a fluidic path between the degasser and the gradient proportioning valve may be configured to maintain a temperature of the portion at a temperature of the gradient proportioning valve.

The temperature control module may include one or more temperature sensors and may include a thermal chamber. A heater may be disposed inside the thermal chamber and configured to heat an internal environment of the thermal chamber to a temperature greater than an ambient temperature. The thermal chamber may include an enclosure having a thermally controlled internal environment and substantially surrounding at least one of the plurality of solvent reservoirs and the gradient proportioning valve. The enclosure may include a thermally insulated housing.

The temperature control module may include an active thermal element in thermal communication with at least one of the plurality of solvent reservoirs and the gradient proportioning valve. The active thermal element may be a heater or a cooling device.

In another aspect, a solvent manager includes a plurality of solvent reservoirs, a gradient proportioning valve, a degasser, and a thermal chamber. The gradient proportioning valve is in fluid communication with the plurality of solvent reservoirs. The degasser is configured to receive and pass a flow of one or more solvents from the solvent reservoirs to the gradient proportioning valve. The thermal chamber has an enclosure with a thermally controlled internal environment and substantially surrounds at least one of the plurality of solvent reservoirs, gradient proportioning valve and degasser. The thermal chamber is configured to maintain a substantially constant temperature of at least one of the plurality of solvent reservoirs, gradient proportioning valve and degasser.

The solvent manager may further include an active thermal element disposed inside the thermal chamber. The active thermal element may be a heater or a cooling device.

At least one temperature sensor may be disposed inside the enclosure.

### BRIEF DESCRIPTION OF THE DRAWINGS

The above and further advantages of this invention may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles of the invention.

FIG. 1 is an illustration of an example of a liquid chromatography system.

FIG. 2 is a graphical representation of the results of a system performance evaluation based on injections performed at different system temperatures for two liquid chromatography systems.

FIG. 3 graphically depicts according to one plot a temperature of the system components inside a temperature-controlled chamber for different injection runs according to injection number and graphically depicts by the other plots the retention time according to injection number and corresponding system components within the temperature-controlled chamber.

FIG. 4 schematically depicts the system configuration used to generate the data for the plot in FIG. 3 corresponding to the solvent reservoirs, degasser, and gradient proportioning valve (GPV) being outside the temperature-controlled chamber.

FIG. 5 schematically depicts the system configuration used to generate the data for the plot in FIG. 3 corresponding to the the solvent reservoirs and GPV being outside the temperature-controlled chamber and the degasser located inside the temperature-controlled chamber.

FIG. 6 schematically depicts the system configuration used to generate the data for the plot in FIG. 3 corresponding to the solvent reservoirs and degasser being outside the temperature-controlled chamber and the GPV located inside the temperature-controlled chamber.

FIG. 7 schematically depicts the system configuration used to generate data for the plot in FIG. 3 corresponding to only the solvent reservoirs being outside the temperature-controlled chamber and the degasser and GPV located inside the temperature-controlled chamber.

### DETAILED DESCRIPTION

Reference in the specification to “one embodiment” or “an embodiment” means that a particular, feature, structure or characteristic described in connection with the embodiment is included in at least one embodiment of the teaching. References to a particular embodiment within the specification do not necessarily all refer to the same embodiment.

The present teaching will now be described in detail with reference to exemplary embodiments thereof as shown in the accompanying drawings. While the present teaching is described in conjunction with various embodiments and examples, it is not intended that the present teaching be limited to such embodiments and examples. On the contrary, the present teaching encompasses various alternatives, modifications, and equivalents, as will be appreciated by those of skill in the art. For example, various embodiments described herein refer to solvents although it should be recognized that other fluids can be used. Those of ordinary skill having access to the teaching herein will recognize additional implementations, modifications, and embodiments, as well as other fields of use, which are within the scope of the present disclosure as described herein.

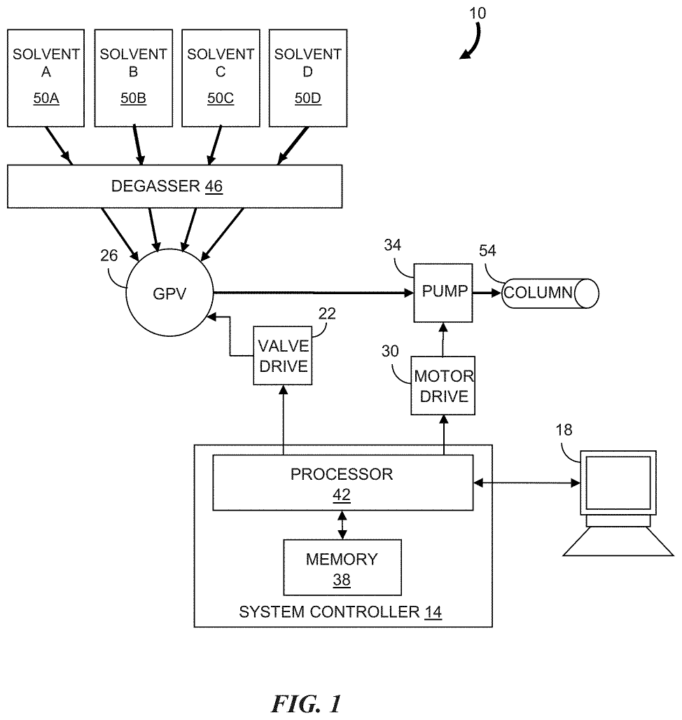

Referring to FIG. 1, an example of a conventional liquid chromatography system 10 includes a system controller 14 that communicates with a user interface module 18 which receives input data and displays system information. The system controller 14 also communicates with a valve drive module 22 for operating a gradient proportioning valve (GPV) 26 and a motor drive module 30 for operating one or more stepper motors for a pump system 34. In one implementation, the pump system 34 includes complementary pump heads that are operated in a synchronized manner as is known in the art. The system controller 14 further includes a memory module 38 and a processor 42. The processor 42 is configured to read data from and write data to the memory module 38. For example, the processor 42 can receive input data from the user interface 18, measurement data from one or more analytical detectors (not shown) and data from various control components and system sensors.

The illustrated system 10 includes a quaternary solvent manager (QSM) that meters and mixes up to four solvents at low (i.e., ambient) pressure. The solvent mixture is pressurized to a system pressure level by the pump system 34 before delivery to the downstream components of the system 10. The GPV 26 includes a plurality of fluid switching valves (e.g., solenoid valves) that are in fluid communication, by tubing or other form of fluidic conduit, with respective solvent component reservoirs 50A, 50B, 50C and 50D. A degasser 46 disposed between the solvent reservoirs 50 and the GPV 26 removes dissolved gases from the individual solvents. The GPV outlet port is coupled to the inlet port of the pump system 34. The solvent mixture is delivered from the pump outlet port to a chromatographic column 54, typically at a substantially higher pressure than the pressure of the solvent mixture exiting the GPV 26.

During operation of the liquid chromatography system 10, the switching valves of the GPV 26 are opened sequentially for each metering cycle so that the pump system 34 draws a volume of fluid from each of the reservoirs 50 contributing to the solvent mixture. The volume proportions of solvents present in the solvent mixture depend on the actuation times for each of the switching valves in relation to the inlet velocity profile during the intake cycle. Thus, the mass composition of the fluid mixture is also determined by the actuation times.

The viscosity and density of a solvent are dependent on the solvent temperature. Moreover, the viscosity change of a solvent for a given temperature change may be different for different solvents. Similarly, the change in the density of a solvent for a given temperature change can differ between the solvents. Generally, if the temperature of the solvents change, the composition of the solvent mixture delivered by the pump system 34 also changes. Thus, ambient temperature changes may cause the solvent mixture composition to differ from the desired solvent composition. A consequence of a temperature change can be a significant increase or decrease in retention times.

An experimental setup was configured to evaluate the effect of temperature variations on the performance of two ACQUITY ARC® liquid chromatography systems. Each system had similar components, including a quaternary solvent manager QSM-R, a flow through needle FTN-R sample manager, a CM-A column heater and a 2489 ultraviolet/visible detector. In addition, each system used a CORTECS® 4.6×50 mm, 2.7 μm C18 BEH column. These systems and components are available from Waters Corporation of Milford, Mass.

The sample used to determine retention time was alkylphenone in a 90:10 water:acetonitrile diluent. The gradient composition was a water and acetonitrile mixture that transitioned linearly from 10% acetonitrile to 60% acetonitrile over 15 minutes and the flow rate was 0.8 mL/minute.

To affect temperature changes on each liquid chromatography system in a controlled manner, the system was placed in a temperature-controlled chamber and the chamber was maintained at different temperatures between approximately 4° C. to approximately 40° C. while the room temperature was maintained at 22° C.±0.5° C. Injections were performed at different temperatures across the temperature range to determine the dependence of retention time on temperature.

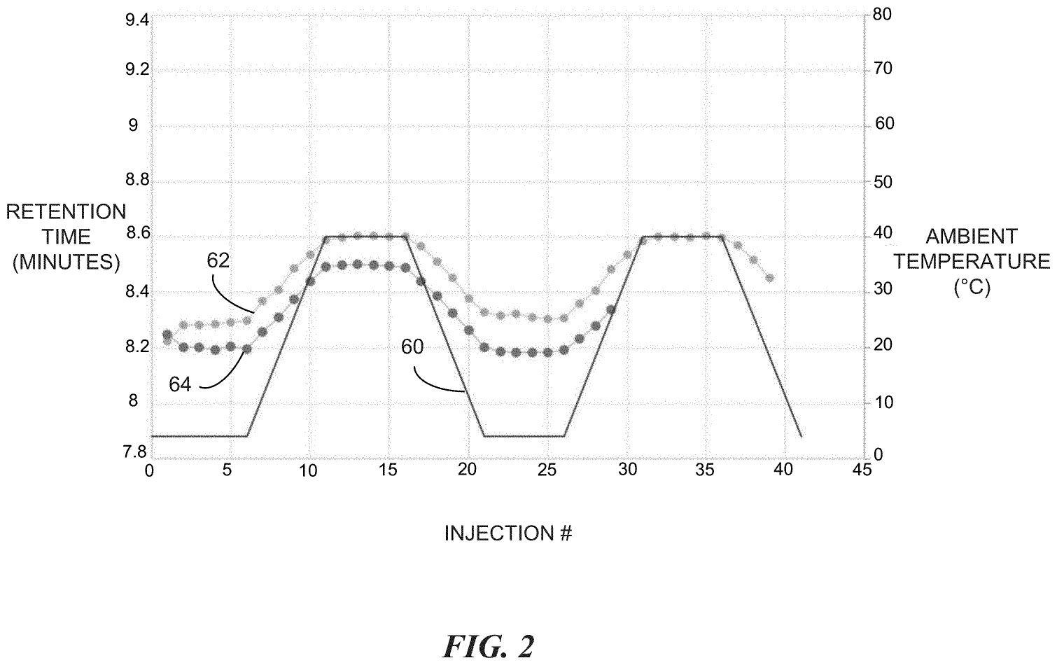

FIG. 2 is a graphical representation of the results of the evaluation of the two systems across the temperature range. The horizontal axis represents the injection sequence number where each injection was performed at a temperature indicated by a temperature ramp plot 60 and the corresponding temperature according to the right vertical axis. The plot 62 corresponding to one system and the plot 64 corresponding to the other system demonstrate the effect of temperature on retention time as indicated by the left vertical axis. The retention time varies with temperature based at least on the relative changes in solvent viscosities and densities for the solvent components of the solvent mixture.

To better determine the liquid chromatography system components that are more thermally sensitive with respect to retention time, an evaluation was performed using different configurations of a solvent manager of the liquid chromatography systems. Each configuration included an arrangement in which one or more solvent manager components were temperature-controlled while the remainder of the solvent manager components and the other system components were exposed to a range of temperatures, again between about 4° C. to about 40° C. To achieve this arrangement in an experimental setup, injections were performed with the liquid chromatography system disposed inside a temperature-controlled chamber while one or more components were “temperature controlled,” that is, maintained at ambient temperature by locating the component(s) outside the chamber and coupling the solvent flow between the outside component(s) and the chamber through tubing. In this manner, components outside the chamber were not subject to the range of internal temperatures generated by the chamber.

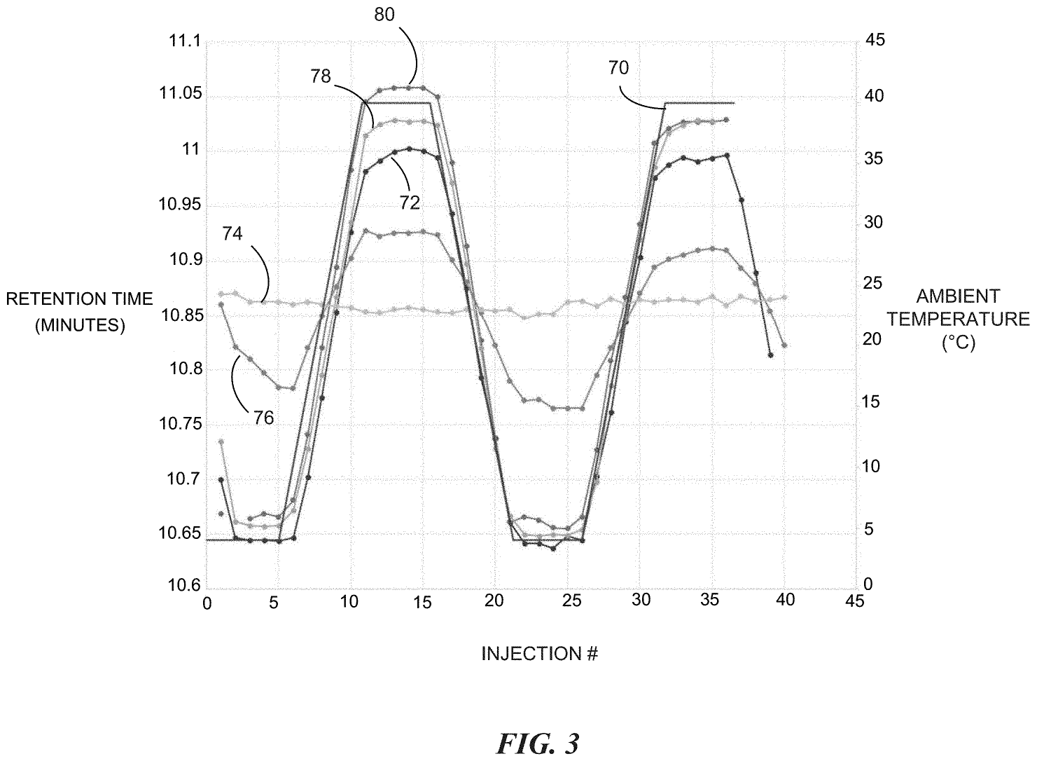

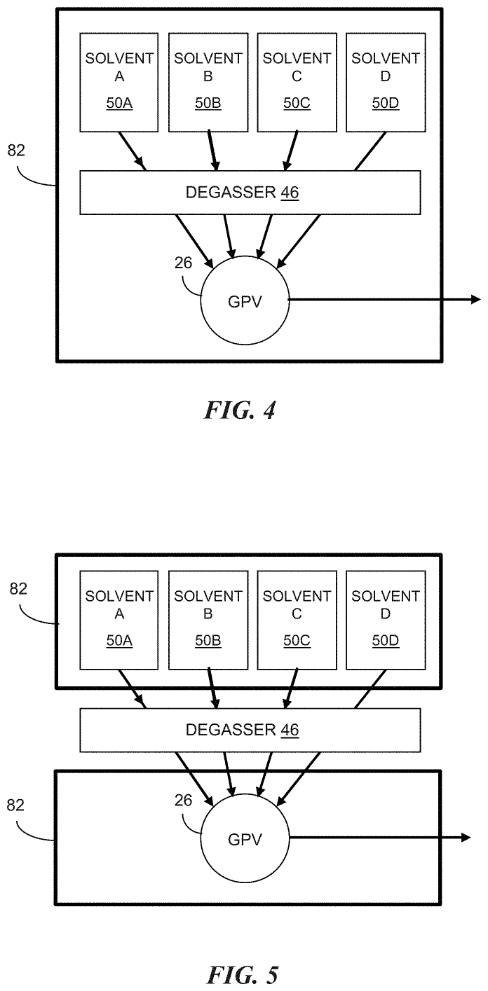

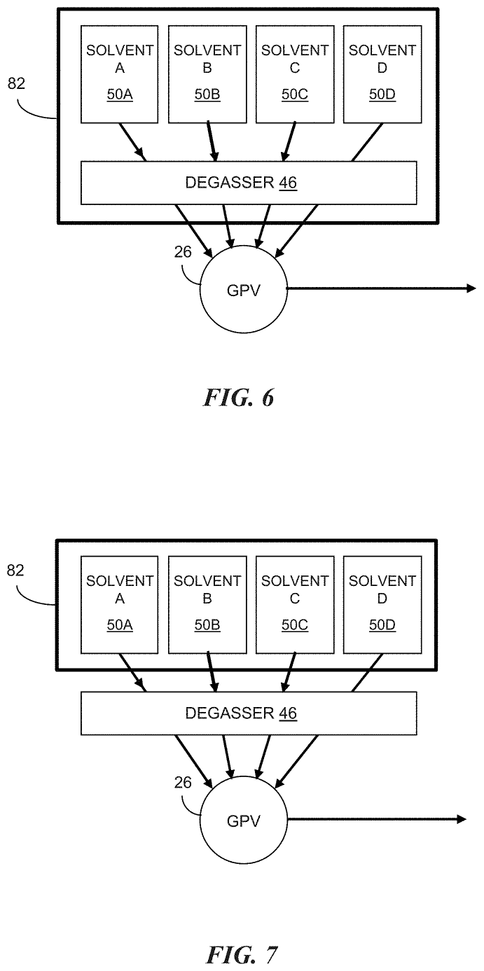

FIG. 3 shows a temperature ramp plot 70 indicating a temperature of the system components inside the temperature-controlled chamber for each injection run according to injection number per the horizontal axis and temperature according to the right vertical axis. The other plots in the figure correspond to different configurations in which the system components inside the chamber varied. Plot 72 represents the temperature dependence for injections performed with all system components inside the chamber. FIGS. 4 to 7 schematically indicate, by inclusion inside rectangle (or rectangles) 82, which component or components were outside the chamber during each group of injections. Plot 74 corresponds to injections performed according to FIG. 4 with the solvent reservoirs 50, degasser 46 and GPV 26 outside the chamber. Plot 76 corresponds to injections performed according to FIG. 5 with the solvent reservoirs 50 and GPV 26 outside the chamber while the degasser 46 was disposed inside the chamber. Plot 78 corresponds to injections performed according to FIG. 6 with the solvent reservoirs 50 and degasser 46 outside the chamber and plot 80 corresponds to injections according to FIG. 7 with only the solvent reservoirs 50 outside the chamber.

It can be seen from FIG. 3 that the greatest benefit in terms of regulating a single component to reduce variations in retention time is associated with regulating the temperature of the GPV 26 although preferably the solvent reservoirs 50, degasser 46 and GPV 26 are all temperature regulated. For example, a temperature-controlled degasser may act as a preheater for the different solvents flowing to the GPV 26. Alternatively or in addition, at least a portion of the fluidic path (e.g., tubing) downstream from the degasser 46 may be actively temperature controlled to allow the different solvent flows to be controlled to the same temperature as the GPV 26. These configurations avoid the problem of insufficient time for the solvents to reach the same temperature of the GPV 26 that might otherwise occur without upstream temperature control.

In embodiments of a liquid chromatography system having reduced sensitivity to temperature variations, temperature control of the gradient proportioning valve, solvent reservoirs and/or degasser may be accomplished in a variety of ways. For example, a temperature control module may be disposed inside the solvent manager and used to regulate the temperature of one or more of these system components. In one example, the temperature control module may include a thermal chamber configured to maintain a substantially constant temperature of one or more of the components. As used herein, a substantially constant temperature means a temperature that varies only by an amount that does not lead to any measurable change in retention time or at least a change in retention time that does not change the characteristics of a chromatogram as perceived by one of skill in the art. The thermal chamber may include an enclosure that substantially surrounds all components that are temperature regulated and provides a thermally controlled internal environment. The enclosure may include a thermally insulated housing to decrease thermal conductance between the regulated components and the environment external to the housing. Optionally, multiple thermal chambers may be used if more than one system component is temperature controlled. In a different example, the gradient proportioning valve, solvent reservoirs and/or degasser may be thermally controlled via an active thermal element (e.g., a heater) in direct thermal communication with the component through a thermally conductive path. In some implementations the heater is used to maintain a temperature that is above the ambient temperature for the liquid chromatography system.

In some of the examples discussed above, the temperature control module is described as having a heater to establish the desired temperature of the regulated system components although it should be recognized that a cooling device could instead be used. Generally, a heater is preferred due to lower cost. The temperature of the controlled system components should be set at a safe margin above the highest ambient temperature anticipated for the instrument environment. For example, the regulated temperature may be 5° C. or 10° C. above the nominal ambient temperature. Conversely, if regulation is achieved by cooling, the regulated temperature should be 5° C. or 10° C. less than the nominal ambient temperature. The regulated temperature is preferably maintained at a substantially constant temperature. For example, the temperature may be considered to be substantially constant if the minimum and maximum values of the regulated temperature over time differ by no more than 1° C.

The temperature control module may include one or more temperature sensors disposed near or at the solvent reservoirs 50, degasser 46 and/or GPV 26. For example, the temperature sensors may be used as part of a control loop for thermal control. For example, the temperature sensors can be thermocouples or thermistors and may be mounted to measure the air temperature within an enclosure that surrounds the temperature-controlled components.

Regulating the temperature of one or more of the GPV 26 and the other components of the low pressure mixing portion of the chromatography system results in a reduction in retention time thermal dependence. Regulating all the low-pressure components, that is, the GPV 26, solvent reservoirs 50 and degasser 46, so that they are at a substantially constant temperature results in substantially no retention time thermal dependence. In this regard, substantially no thermal dependence of retention time means the retention time may vary but such variations would not render any detrimental effect on retention time data for chromatographic peaks as interpreted by one of skill in the art. Thus, users would not consider the variations in retention time to render the system measurement data unsuitable for typical chromatographic separations.

While the invention has been shown and described with reference to specific embodiments, it should be understood by those skilled in the art that various changes in form and detail may be made therein without departing from the spirit and scope of the invention as recited in the accompanying claims.

What is claimed is:

1. A liquid chromatography system, comprising:
a solvent manager comprising:
a plurality of solvent reservoirs; and
a gradient proportioning valve in fluid communication with the plurality of solvent reservoirs; and
a temperature control module disposed in the solvent manager and configured to maintain a substantially constant temperature of at least one of the plurality of solvent reservoirs and the gradient proportioning valve.

2. The liquid chromatography system of claim 1 wherein the solvent manager further comprises a degasser disposed between the plurality of solvent reservoirs and the gradient proportioning valve and wherein the temperature control module is configured to maintain a substantially constant temperature of at least one of the plurality of solvent reservoirs, the gradient proportioning valve and the degasser.

3. The liquid chromatography system of claim 1 wherein the temperature control module comprises a thermal chamber.

4. The liquid chromatography system of claim 3 wherein the thermal chamber comprises an enclosure having a thermally controlled internal environment and substantially surrounding at least one of the plurality of solvent reservoirs and the gradient proportioning valve.

5. The liquid chromatography system of claim 4 wherein the enclosure comprises a thermally insulated housing.

6. The liquid chromatography system of claim 1 wherein the temperature control module comprises an active thermal element in thermal communication with at least one of the plurality of solvent reservoirs and the gradient proportioning valve.

7. The liquid chromatography system of claim 6 wherein the active thermal element is a heater.

8. The liquid chromatography system of claim 6 wherein the active thermal element is a cooling device.

9. The liquid chromatography system of claim 3 further comprising a heater disposed inside the thermal chamber and configured to heat an internal environment of the thermal chamber to a temperature greater than an ambient temperature.

10. The liquid chromatography system of claim 1 wherein the temperature control module comprises at least one temperature sensor.

11. The liquid chromatography system of claim 2 wherein at least a portion of a fluidic path between the degasser and the gradient proportioning valve is configured to maintain a temperature of the portion at a temperature of the gradient proportioning valve.

12. A solvent manager, comprising:
a plurality of solvent reservoirs;
a gradient proportioning valve in fluid communication with the plurality of solvent reservoirs;
a degasser configured to receive and pass a flow of one or more solvents from the solvent reservoirs to the gradient proportioning valve; and
a thermal chamber having an enclosure with a thermally controlled internal environment and substantially surrounding at least one of the plurality of solvent reservoirs, gradient proportioning valve and degasser and configured to maintain a substantially constant temperature thereof.

13. The solvent manager of claim 12 further comprising an active thermal element disposed inside the thermal chamber.

14. The solvent manager of claim 13 wherein the active thermal element is a heater.

15. The solvent manager of claim 13 wherein the active thermal element is a cooling device.

16. The solvent manager of claim 12 further comprising at least one temperature sensor disposed inside the enclosure.
